(19) United States
(12) Patent Application Publication
(10) Pub. No.: US 2006/0257182 A1
(43) Pub. Date: Nov. 16, 2006

(54) Printing device

(76) Inventors: Bernd Schultheis, Schwabenheim (DE); Dieter Jung, Daaden (DE); Holger Kobrich, Florsheim (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/567,471

(22) PCT Filed: Jul. 16, 2004
(86) PCT No.: PCT/EP04/07962

§ 371 Date: Feb. 6, 2006

(30) Foreign Application Priority Data
Aug. 6, 2003 (DE) 103 35 920.6

(51) Int. Cl. G03G 15/00

(52) U.S. Cl. 399/390

(57) ABSTRACT

A printing device, including at least one electrophotographic printing unit with a transfer medium for the transfer of a toner powder to a substrate in a transfer zone. One or several substrates may be run through the transfer zone by a transport system. The transport system includes a heated housing device for each substrate, having one or several heating elements for the introduction of heat energy into the substrate. A cooling device is provided for the transfer medium of each printing unit, which extracts heat energy from the transfer medium. There can be a number of serially arranged printing units, for the printing of each substrate, each with a different color.

### BACKGROUND OF THE INVENTION

1. Field of the Invention

This invention relates to a printing device, having at least one electro-photographic printing unit, to which a transfer medium for transferring a toner powder to respectively one substrate in a transfer zone is assigned, wherein one or several substrates can be conducted through the transfer zone by a transport system.

2. Discussion of Related Art

A printing device is known from U.S. Pat. No. 5,988,068. A revolving endless belt is assigned as the transfer medium to an electro-photographic printing unit. A photo-conductor rolls off the latter for transferring an image having toner powder. The toner image can be applied to a substrate. Thus, the substrate is conducted past the transfer medium by a transport system. In this case the transfer medium rolls off the substrate surface to be imprinted. According to U.S. Pat. No. 5,988,068, there are two heating elements for improving the toner transfer. The first heating element heats the substrate to a temperature higher than 60° C. The second heating element acts on the transfer medium at a temperature of more than 160° C. It has thus been shown to be disadvantageous, in particular when printing with ceramic toners, that residues of the toner stick to the transfer medium. Because of the doughy consistency at this temperature, they can only be removed with great difficulty, or not completely. Furthermore, heat is introduced into the electro-photographic printing device during continuous operation. This leads to a worsening of the image quality. Printing is only possible in one color with the printing device known from U.S. Pat. No. 5,988,068.

However, it is also known to realize a multi-color printing device because several printing devices of basically the same type are arranged one behind the other, wherein the substrate to be imprinted is sequentially conducted to the individual printing devices for applying respective one-color prints. Thus, a toner with a different color is available in each printing device. A substrate imprinted in multi-color exists after passage over the entire printing path. In this case, the introduction of heat into the entire printing device can be very large because of the mutual temperature effects of the individual printing devices, so that the above described problems in connection with printing by ceramic toners can increase.

### SUMMARY OF THE INVENTION

It is one object of this invention to provide a printing device of the type mentioned above but with an improved toner transfer from the transfer medium to the substrate. Also, when used in a multi-color printing installation, the printing device is also intended to avoid the known problems, in particular because of the excessive heat introduction.

This object is attained with a transport system for the one or every substrate each having a receiving device which can be heated, to which one or several heating elements for introducing heat energy into the substrate are assigned. With such an arrangement, the area to be heated is substantially limited to the substrate, so that heating of the printing unit, or the introduction of heat, beyond this is limited. Thus, in an arrangement of several adjoining printing units the mutual thermal influence is also reduced.

In addition, a cooling device is assigned to the transfer medium of the respective printing unit, which removes heat energy from the transfer medium.

With the cooling of the transfer medium, following the transfer to the substrate, the toner powder does not adhere to the surface of the transfer medium, but during the transfer is almost completely released. The heat introduction into the printing unit, in particular into the sensitive photo-conductor, is also prevented, or at least minimized to a permissible amount, because of the cooling.

Heating, which is substantially restricted to the substrate, is achieved if the heating element is arranged on the side of the substrate facing away from the receiving device of the transport system. Thus, the underside of the substrate is substantially heated over its entire surface, so that good heat penetration up to the substrate surface is assured. Excess heating of the surroundings is avoided.

In order to minimize undesired heat transfer into the receiving device, while at the same time assuring the placement of the heating device at the receiving device in the area of the substrate underside, the receiving device can have an approximately frame-shaped receiving structure for supporting one substrate. Thus a support and fixation of at least areas of the substrate at the receiving device is assured.

In accordance with a preferred embodiment, it is possible to realize a multi-color printing device with a plurality of printing units arranged one behind the other. In this case, single-color printing is performed in each printing unit, wherein toners of different color are employed in the different printing units.

A plurality of substrates can be arranged one behind the other can be conducted by the transport system through the transfer zones of each one of the printing units. Thus it is possible to achieve a particularly high throughput, in particular if the transport system moves on the respective substrate, or arrangement of substrates, continuously.

In one embodiment, each substrate is received in a separate receiving device, upstream in the transport direction, of the first of the printing units arranged one behind the other. Thereafter the substrate, or the sequence of the substrates, is conducted in the respective receiving devices one after the other to the individual printing units. Following the last one of the printing units arranged one behind the other, each of the imprinted substrates can be removed again from the respective receiving device.

In this case, after having been taken out of the receiving device, the substrate can be transferred to a transfer unit or a sorting unit, for a partial or a fully automatic handling of the imprinted substrates.

In connection with a multi-color printing device in particular, the transport system can have a conveying arrangement which transports every receiving device along a guidance arrangement. Here, the conveying arrangement can have at least one toothed belt, continuously revolving endless belts, or like conveying elements. Such a conveying arrangement causes an advancing movement of the respective receiving device. In this case, the guidance device can be an arrangement of guide rods or guide rails, or similar guide elements.

In one embodiment, the guidance arrangement can form a closed track, or a conveying circuit, for conveying the receiving devices. A particularly compact printing device can be realized with such an arrangement. During this the receiving devices can have exactly guiding linear bearings, which leave the guide elements in the area of the course changes of the conveying circuit and, after passing through the course changes, are caught again in the conically designed guide elements and are centered.

In a particularly advantageous embodiment, a cleaning device for the receiving devices can be arranged at the closed track or at the conveying circuit. It is thus possible to dependably remove the dirt accumulation on the receiving devices, which is unavoidable, in particular when printing.

The cleaning device can be preferably arranged following the last of the printing units arranged one behind the other in the conveying direction of the receiving devices. Following the removal of the respective substrate, the soiled receiving device is introduced into the cleaning installation. After passing through the cleaning installation, the cleaned receiving device is again available for receiving a substrate to be imprinted. For this purpose, the cleaning device can be arranged upstream of the first of the printing units arranged one behind the other in the conveying direction of the receiving devices.

In accordance with one embodiment of this invention, the transfer medium has a lower temperature in the transfer zone formed with the substrate, at least in the area of the contact surface, than the surface of the substrate. In this case, a heat flow can take place at most from the substrate to the transfer medium. Then the cooling device draws off this heat, at least the largest part of it, in a controlled way. In this case, the transfer medium can be embodied as a transfer roller or transfer belt containing at least a portion of the cooling device.

Alternatively or in addition, the substrate can also be placed on a conductive support of the receiving device. In connection with negatively charged toners, the support is positively charged. Correspondingly negatively with positively charged toners. The voltages of the charges can be reduced so that negative field effects, such as occur with toner transfers generated purely by electrostatic fields alone, no longer occur.

For achieving a particularly good toner transfer it is possible to move the substrate by the transport system past or beyond the transfer medium synchronously with the circumferential speed of the transfer medium. It is thus possible to apply a voltage to each receiving device in the transport system which, with respect to the transfer medium, is opposite to the charge of the toner.

A particularly effective heating of the substrate can take place if the substrate can be charged by an infrared radiation device and/or a heating element embodied as a hot-air blower and/or by charging with heat energy. In this case, the temperature should be set as a function of the toner used. Tests with ceramic toners having a proportion of solid materials, such as pigments, or glass flit, of 50 to 70% have shown that a surface temperature of the substrate of between 220° C. and 150° C. is particularly advantageous. After being transferred, the toner powder should melt and adhere to or on the substrate. If the toner powder melts completely, a subsequent fixation can possibly become unnecessary.

Particularly effective heating of the substrate can occur by metal tape heating or metal foil heating, in which a temperature is created whose wavelength is exactly matched to the absorption maximum of the substrate and the plastic matrix of the toner. A further advantage of the metal heating and metal foil heating is in the low mass of the heat conductors, and thus in a very steep characteristic heating and cooling line.

On the one hand, the print medium can be of a thermoplastic matrix, in which organic or inorganic color pigments and/or small glassy flow particles can be embedded, for coloring.

In another case the plastic matrix is of a mixture of hardening and binder resins, or of polymers which, at temperatures >160° C., react to form thermosetting, such as a rule spatially cross-linked, structures, in which organic or inorganic color pigments can also be embedded.

Furthermore, other additives, such as particles capable of conducting, or mechanically resistant materials can also be contained, which later on result in an electrically conductive coating or a scratch-protection layer.

It can be necessary to keep the substrate temperature as low as possible and match it to the substrate to be imprinted. This is of particular importance with highly temperature-sensitive plastic substrates or with glass which is less resistant to temperature differences. It is thus necessary to match the plastic matrix of the print media so that the softening point of the matrix is also lowered. This is of particular interest if, in the case of additives such as ceramic pigments or small glassy flow particles, the softening temperature rises with an increase in the proportion of the solid materials in the plastic matrix.

A reduction of the softening temperature in case of an increase in the proportion of the solid materials occurs, for one, by the addition of polymer additives, such as wax, or by the use of a different, lower melting plastic matrix.

For achieving control of the substrate temperature, a temperature sensor, for example a pyrometer, can be assigned to the substrates, or to each one of the substrates, and the heating element and/or the transport system can be controlled by a control device as a function of the signal emitted by the temperature sensor.

It is thus possible to regulate the temperature by acting on the transport system via the advancement time of the substrate, or its loitering time in areas outside of the transfer zone. Thus, for example in case of an arrangement of several printing units in series, the heat output of the heating elements can be reduced when the substrate is not located in a transfer zone, for example in the area between two adjoining printing units.

The regulation can occur so that the substrate always enters a transfer zone at a constant surface temperature. During transfer, the substrate surface should be uniformly heated.

To achieve an effective temperature of the transfer medium, one or several liquid-cooled contact rollers of the cooling device can roll off on the transfer medium, and/or a conditioned air flow can be directed on the surface of the transfer medium.

It is also possible for the transfer medium to be embodied as a transfer roller which contains at least a part of the cooling device. In this case, the cooling device can also have one or several Peltier elements. Alternatively or in addition, the transfer roller can also be water-cooled or air-cooled.

If the cooling device removes heat energy from the transfer medium downstream of the transfer zone and upstream of the photo-conductor of the printing unit, viewed in the transport direction of the transfer medium, then the introduction of heat into the photo-conductor is dependably prevented.

### BRIEF DESCRIPTION OF THE DRAWINGS

This invention is described in greater detail in view of an exemplary embodiment represented in the drawings, wherein:

FIG. 1 shows a single-color printing device with a printing unit, in a schematic lateral view; and

FIG. 2 shows a multi-color printing device in a schematic lateral view, with six printing units in accordance with FIG. 1 arranged in series, and with a cleaning device, which circulates in a printing circuit, for receiving devices for substrates to be imprinted.

### DESCRIPTION OF THE INVENTION

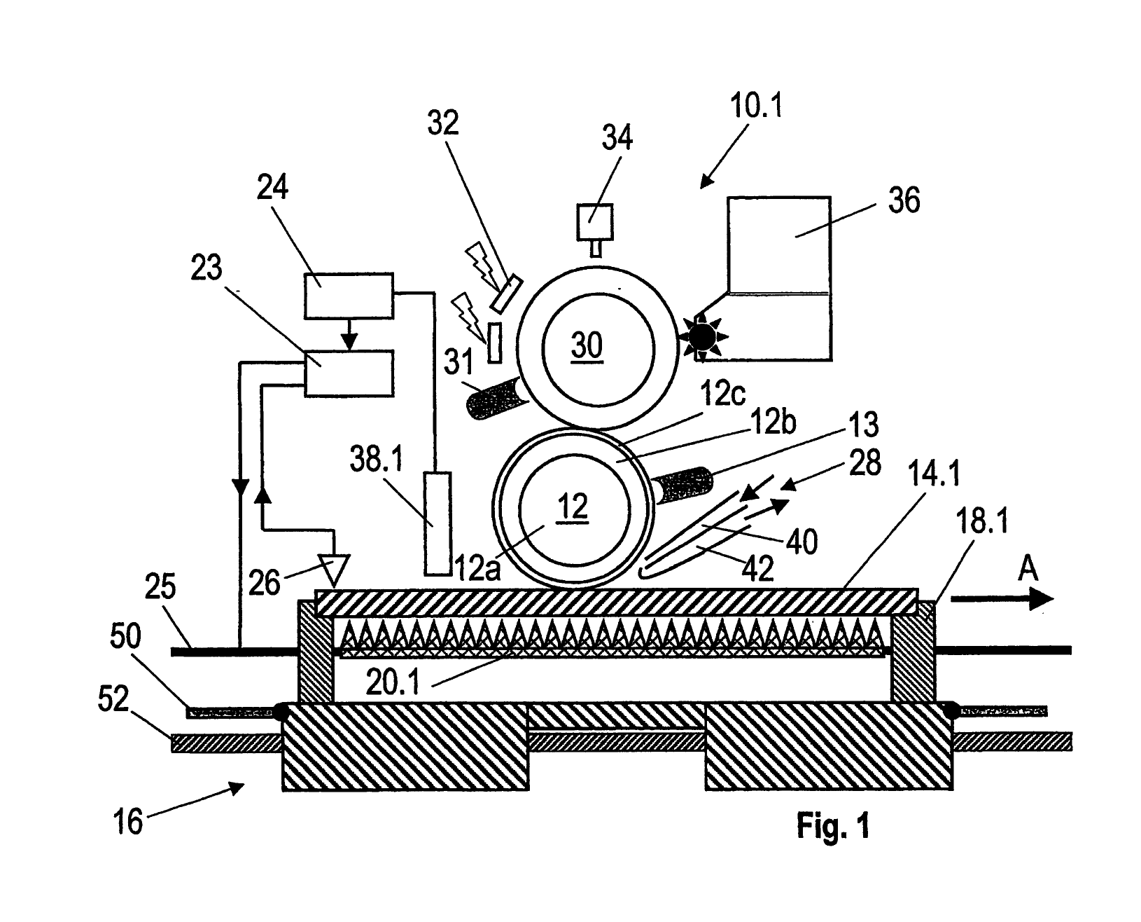

A printing device with an electro-graphic printing unit 10.1 is shown in FIG. 1. It has a roller-shaped photo-conductor 30 and has a uniform charge on its surface, by a charging corona 32. This charge is partially removed, corresponding to the pattern to be printed, by an adjoining LED-writing head or a laser arrangement 34, so that a lateral charge image is created. A developer unit 36 applies toner powder to the discharged areas of the photo-conductor surface. The toner image thus developed is transferred in a transfer zone to a transfer medium 12. The transfer medium 12 has a base roller body 12a. A resilient, electrically semi-conducting intermediate layer 12b is applied to the base roller body 12a. It can comprise, for example, silicon, EPDM or polyurethane. An anti-adhesion coating 12c is arranged indirectly or directly above the intermediate layer 12b and forms the roller surface.

A cleaning unit 31 is arranged at the photo-conductor 30, and a cleaning unit 13 at the transfer medium 12, which remove toner residue with cleaning brushes and suitable strippers and return it to the developer unit 36 via suitable toner return worms.

A transport system 16 is arranged below the transfer medium 12 and has an approximately frame-shaped receiving device 18.1, which is movable toward the right in the direction of the arrow A, and on which a substrate 14.1 can be conveyed. Here, the transport system 16 is arranged so that the transfer medium 12 rolls off on the surface to be imprinted of the substrate 14.1. In the process, the toner powder on the transfer medium is transferred onto the substrate 14.1.

The transport system 16 comprises a guide rod 52, along which the receiving device 18.1 is guided by engaging guide devices, not represented. The advancing movement in the direction A is provided by a motor-driven toothed belt 50.

A panel heating element, or several individual heating elements 20.1, are arranged inside the receiving device 18.1 and act on the underside of the substrate 14.1 and heat the substrate so that the surface is uniformly heated to a temperature within a range between 160° C. and 170° C. One or several temperature sensors 26 are arranged between the heating elements 20.1 and the transfer medium 12, for monitoring the temperature and transmit a temperature signal to one or several regulators 23. The regulator 23 reads in a preset value via a control device 24. The preset value is compared with the temperature signal. In case of a temperature difference, the heating elements 20.1 can be readjusted. The heating element 20.1 is supplied via a bus bar 25.

In a supporting way, it is also possible to regulate the transport speed of the transport system 16 in the area of or near the transfer medium 12. It is thus assured that the substrate 14.1 always enters the transfer zone at an approximately constant surface temperature.

A sensor unit 38.1 is arranged in the area upstream of the transfer medium in the transport direction A of the transport system 16, which, in the manner of a light barrier, puts the printing unit 10.1 into operation as soon as it is detected and the substrate 14.1, or the receiving device 18.1 with the substrate 14.1 arranged therein, enters the transfer zone. This detection signal can be provided to the control device 24 which, by the regulator 23, increases the heating output of the heating elements 20.1 so that the temperature required or preferred for hot transfer is reached in the substrate 14.1.

A cooling device 28 is assigned to the transfer medium 12. It has an air inflow conduit 40. It is possible to blow a gaseous cooling medium, preferably conditioned air, through this onto the surface of the transfer medium 12. The air removes heat energy from the transfer medium 12. The heated fluid flow can then again be drawn off via a return air flow conduit 42. The return air flow conduit 42 prevents gas flows from being created outside the cooling zone, which could lead to a damage of the toner image maintained on the transfer medium 12 or the photo-conductor 30.

In an alternative embodiment, not represented, the cooling device has one or several water-cooled rollers, which are in surface contact with the transfer medium. The rollers are connected with a temperature-regulating unit and withdraw heat energy from the transfer medium. The water coming from the rollers is conducted to the temperature-regulating unit via a circulation system. It is cooled in the temperature-regulating unit and is then again conducted to the rollers.

In a further embodiment, not shown, the core of the transfer roller comprises a material with good heat-conducting properties, for example copper, aluminum or ceramic materials, such as SiC or Si3N4 and, if desired, has cooling fins and is cooled by an airflow in the interior of the transfer roller. The core is coated with a 1 to 2 mm thick, flexible, heat-conducting material, such as PTFE, FPM, silicon or PUR plastic, filled with a glass or mineral material, for example.

A transfer belt with an interior blower is also possible, so that cooling over a large surface with a relatively small air flow is possible.

It is advantageous if zone heating, not represented, is provided on the receiving device 18.1 over the printing width defined by a width of the fed-in substrate. With such zone heating it is possible to regulate the heat output in the edge area of the substrate surface, respectively separately toward the center. This has one advantage that the surface temperature can be better regulated over the printing width, and with it the temperature constancy over the printing width can be improved. For this purpose, respectively individual regulators 23 and temperature sensors 26 are assigned to each zone heating element. In this case, the temperature sensors 26 are advantageously in the form of pyrometers which detect the surface temperature of the substrate 14.1.

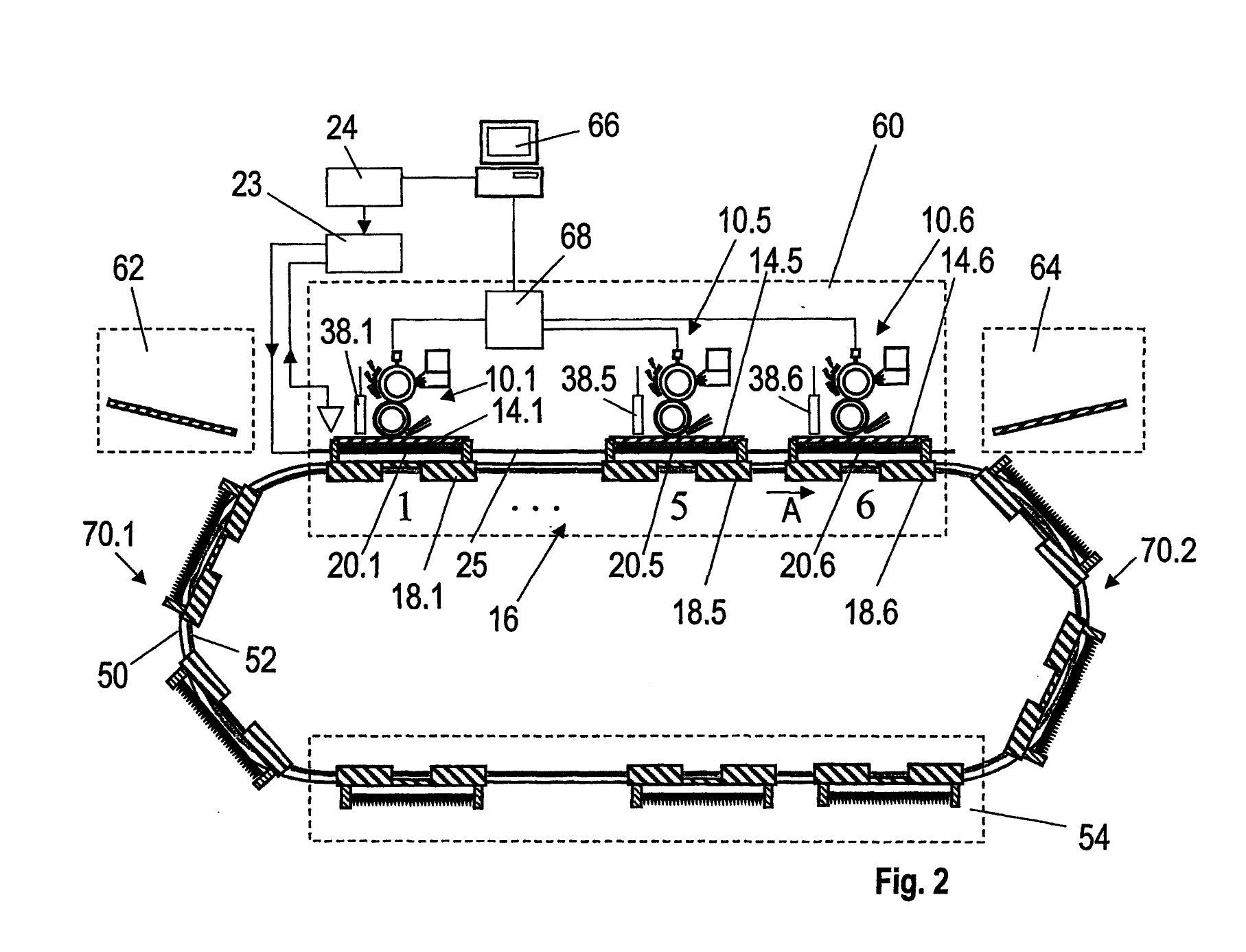

In a schematic lateral view of FIG. 2, a multi-color printing device with six printing units 10.1, . . . , 10.5, 10.6 arranged in series, and a cleaning device 54 for receiving devices 18.1, . . . , 18.5, 18.6 for substrates 14.1, . . . , 14.5, 14.6 circulating in a printing circuit. For the sake of clarity, only three of the six printing units are represented in FIG. 2.

The printing units 10.1, . . . , 10.5, 10.6 are electro-photographic units, such as described in regard to FIG. 1. However, alternatively the individual printing units can also be designed differently. The individual printing units 10.1, . . . , 10.5, 10.6 can be activated by a sensor arrangement 38.1, . . . , 38.5, 38.6 arranged upstream of the assigned printing unit.

The printing units 10.1, . . . , 10.5, 10.6 are arranged in a modular arrangement on a common support frame 60. Because of the modular arrangement, the individual printing units 10.1, . . . , 10.5, 10.6 are easily accessible, which assures cost-effective operations, in particular for maintenance, repair, but also for toner changes. The serial arrangement of the six printing units 10.1, . . . , 10.5, 10.6 allows direct full-color printing by the use of different toner colors in the individual printing units, wherein the complete color print can be applied in one passage.

In this case, operating panels for electric devices, flat glass, plastic panels, light-density laminated plates for the advertising industry, signs, or like media suited for the hot-transfer method are used as substrates 14.1, . . . , 14.5, 14.6 to be imprinted.

The substrates 14.1, . . . , 14.5, 14.6 are conveyed through the multi-color printing device by a transport system 16. In this case, each substrate 14.1, . . . , 14.5, 14.6 is received in a heatable receiving device 18.1, . . . , 18.5, 18.6. The receiving devices 18.1, . . . , 18.5, 18.6 have one or several heating elements 20.1, . . . , 20.5, 20.6 for introducing heat energy into the substrate 14.1, . . . , 14.5, 14.6. For this purpose, each heating element is arranged on the side of the substrates 14.1, . . . , 14.5, 14.6 facing away from the printing units 10.1, . . . , 10.5, 10.6, so that always the underside of the substrates is heated. The heat penetrates the substrate material, so that the surface is also heated.

As described in view of FIG. 1, the heating elements 20.1, . . . , 20.5,20.6 of the receiving devices 18.1, . . . , 18.5, 18.6 are controlled by an arrangement having a regulator 23, a control device 24 and one or several temperature sensors 26. During this, the same temperature conditions are set at all receiving devices 18.1, . . . , 18.5, 18.6 located in the areas of the six printing units 10.1, . . . , 10.5, 10.6. A bus bar 25 is arranged in this area for this purpose, through which the heating elements 20.1, . . . , 20.5, 20.6 are provided with electrical current. However, alternatively it is also conceivable to control the individual heating elements 20.1, . . . , 20.5, 20.6 of the individual receiving devices 18.1, . . . , 18.5, 18.6 separately.

For a secure conveyance through the multi-color printing device, each substrate 14.1, . . . , 14.5, 14.6 is supportingly fixed, at least over some areas, on the assigned receiving device 18.1, . . . , 18.5, 18.6. In the represented embodiment, each receiving device 18.1, . . . , 18.5, 18.6 has an approximately frame-shaped receiver for respectively one substrate 14.1, . . . , 14.5, 14.6.

The transport system 16 is designed so that several substrates 14.1, . . . . 14.5, 14.6 can be continuously conducted, one behind the other, through the transfer zones of each one of the printing units 10.1, . . . , 10.5, 10.6.

A feed unit 62 is arranged in the transport direction A of the transport system 16 upstream of the first printing unit 10.1 of the printing units 10.1, . . . , 10.5, 10.6 arranged one behind the other, in which each substrate to be imprinted is received in a separate receiving device 18.1, . . . , 18.5, 18.6, and is sequentially conveyed to the printing units 10.1, . . . , 10.5, 10.6.

A removal unit 64 is arranged after the last printing unit 10.6 in the transport direction A of the transport system 16, in which each already imprinted substrate 14.1, . . . , 14.5, 14.6 can be taken out of the assigned receiving device 18.1, . . . , 18.5, 18.6. In addition, following the removal from the receiving device 18.1, . . . , 18.5, 18.6, which can take place automatically, each substrate 14.1, . . . , 14.5, 14.6 can be transferred into a transfer unit or a sorting unit.

The transport system 16 has a conveying device 50, which transports each receiving device 18.1, . . . , 18.5, 18.6 along a guide rod 52. Alternatively, the receiving devices 18.1, . . . , 18.5, 18.6 can also be guided in a guide rail or like guide element.

The conveying device 50 has an arrangement of toothed belts driven by electric motors, which are linked, capable of being placed under tension, to each receiving device 18.1, . . . , 18.5, 18.6. Alternatively, an arrangement of a continuously revolving belt or like conveying element can be employed. All receiving devices 18.1, . . . , 18.5, 18.6 are uniformly moved with the aid of the conveying device 50. Thus a closed track, or a transport circuit for the transport of the receiving devices 18.1, . . . , 18.5, 18.6 is formed by the guide arrangement 52.

The transport system 16 is laid out so that the guide devices, not represented, of the receiving devices 18.1, . . . , 18.5, 18.6 which engage the guide rod 52 are disengaged at the course-change locations 70.1 and 70.2 of the closed track, and entry into the linear bearings takes place via cones at the guide rod 52.

A cleaning device 54 for removing dirt or printing ink residue from the receiving devices 18.1, . . . , 18.5, 18.6 is arranged at the closed track or the transport circuit. The cleaning device is arranged, viewed in the transport direction A of the transport system 16, downstream of the last printing unit 10.6 of the printing units 10.1, . . . , 10.5, 10.6 arranged one behind the other, and downstream of the removal unit 64. Each receiving device 18.1, . . . , 18.5, 18.6 is introduced into the cleaning device 54 following the removal of each substrate 14.1, . . . , 14.5, 14.6. Here, the cleaning device 54 is arranged, viewed in the transport direction A of the transport system 16, upstream of the feed unit 62 and upstream of the first printing unit 10.1.

Together with the temperature regulating device at the individual receiving devices 18.1, . . . , 18.5, 18.6, the transport system 16 is controlled by a computer arrangement 66 and a controller circuit 68. In addition, printing software required for the individual printing units 10.1, . . . , 10.5, 10.6, along with the appropriate software tools, is also contained in the computer arrangement 66. It is also possible to perform image processing of the print pattern in the computer arrangement 66.

1. A printing device, having at least one electro-photographic printing unit (10.1), to which a transfer medium (12) for transferring a toner powder to respectively one substrate (14.1, . . . , 14.5, 14.6) in a transfer zone is assigned, wherein one or several more substrates (14.1, . . . , 14.5, 14.6) can be conducted through the transfer zone by mcans of a transport system (16), the printing device comprising:
the transport system (16) for each said substrate (14.1, . . . , 14.5, 14.6) having a receiving device (18.1, . . . , 18.5, 18.6) which can be heated, to which one or more heating elements (20.1, . . . , 20.5, 20.6) for introducing heat energy into the substrate (14.1, . . . , 14.5, 14.6) are assigned, and
a cooling device (28) is assigned to the transfer medium (12) of each said printing unit, which removes heat energy from the transfer medium (12).

2. The printing device in accordance with claim 1, wherein each said heating element (20.1, . . . , 20.5, 20.6) is arranged on a side of the substrate (14.1, . . . , 14.5, 14.6) facing away from the receiving device (18.1, . . . , 18.5, 18.6) of the transport system (16).

3. The printing device in accordance with claim 2, wherein the substrate (14.1, . . . , 14.5, 14.6) is fixed in place at least partially on the receiving device (18.1, . . . , 18.5, 18.6).

4. The printing device in accordance with claim 3, wherein the receiving device (18.1, . . . , 18.5, 18.6) has an approximately frame-shaped receiving structure for supporting the respective substrate (14.1, . . . , 14.5, 14.6).

5. The printing device in accordance with claim 4, wherein a plurality of printing units (10.1, . . . , 10.5, 10.6) are arranged one behind the other for imprinting each said substrate (14.1, . . . , 14.5, 14.6) in a different color.

6. The printing device in accordance with claim 5, wherein the transport system (16) conducts a plurality of the substrates (14.1, . . . , 14.5, 14.6) arranged one behind the other through the transfer zones of each of the printing units (10.1, . . . , 10.5, 10.6).

7. The printing device in accordance with claim 6, wherein the transport system (16) moves the substrate (14.1, . . . , 14.5, 14.6) continuously.

8. The printing device in accordance with claim 7, wherein upstream of the first printing unit (10.1) of the printing units (10.1, . . . , 10.5, 10.6) arranged one behind the other in the transport direction (A) of the receiving device (18.1, . . . , 18.5, 18.6), the substrate (14.1, . . . , 14.5, 14.6) can be received in a separate receiving device (18.1, . . . , 18.5, 18.6) and can be sequentially conducted to the printing units (10.1, . . . , 10.5, 10.6).

9. The printing device in accordance with claim 8, wherein downstream of the last printing unit (10.6) of the printing units (10.1, . . . , 10.5, 10.6) arranged one behind the other in the transport direction (A) of the receiving device (18.1, . . . , 18.5, 18.6), the substrate (14.1, . . . , 14.5, 14.6) can be removed from the respective receiving device (18.1, . . . , 18.5, 18.6).

10. The printing device in accordance with claim 9, wherein following removal from the receiving device (18.1, . . . , 18.5, 18.6) the substrate (14.1, . . . , 14.5, 14.6) can be transferred to a transfer unit or a sorting unit.

11. The printing device in accordance with claim 10, wherein the transport system (16) has a conveying device (50), which transports the receiving device (18.1, . . . , 18.5, 18.6) along a guidance arrangement (52).

12. The printing device in accordance with claim 11, wherein the conveying device (50) has at least one of a toothed belt, a belt, and a conveying element.

13. The printing device in accordance with claim 13, wherein the guidance device can be an arrangement of one of guide rods (52), guide rails, and guide elements.

14. The printing device in accordance with claim 13, wherein the guidance arrangement (52) forms one of a closed track, and a conveying circuit for conveying the receiving device (18.1, . . . , 18.5, 18.6).

15. The printing device in accordance with claim 14, wherein a cleaning device (54) for the receiving device (18.1, . . . , 18.5, 18.6) is arranged at a closed track or the conveying circuit.

16. The printing device in accordance with claim 15, wherein the cleaning device (54) is arranged following the last printing unit (10.6) of the printing units (10.1, . . . , 10.5, 10.6) arranged one behind the other in the conveying direction of the receiving device (18.1, . . . , 18.5, 18.6), and the receiving device (18.1, . . . , 18.5, 18.6) can be introduced into the cleaning device (54) following the removal of the or substrate (14.1, . . . , 14.5, 14.6).

17. The printing device in accordance with claim 16, wherein the cleaning device (54) is arranged upstream of the first printing unit (10.1) of the printing units (10.1, . . . , 10.5, 10.6) arranged one behind the other in the conveying direction (A) of the receiving device (18.1, . . . , 18.5, 18.6).

18. The printing device in accordance with claim 17, wherein the substrate (14.1, . . . , 14.5, 14.6) is respectively received in a separate receiving device (18.1, . . . , 18.5, 18.6) downstream of the cleaning device (54) and upstream of the first printing unit (10.1) of the printing units (10.1, . . . , 10.5, 10.6) in the conveying direction (A) of the receiving device (18.1, . . . , 18.5, 18.6).

19. The printing device in accordance with claim 18, wherein the transfer medium (12) is a transfer roller or a transfer belt containing at least a portion of the cooling device (12).

20. The printing device in accordance with claim 19, wherein the transfer medium (120) of the printing unit (10.1, . . . , 10.5, 10.6) has a lower temperature in the transfer zone formed with the substrate (14.1, . . . , 14.5, 14.6) at least in an area of the contact surface, than a surface of the substrate (14.1, . . . , 14.5, 14.6).

21. The printing device in accordance with claim 20, wherein the substrate (14.1, . . . , 14.5, 14.6) rests on a conductive support of the receiving device (18.1, . . . , 18.5, 18.6) and that the support is charged with a reversed polarity sign compared with the charge of the toner.

22. The printing device in accordance with claim 21, wherein the substrate (14.1, . . . , 14.5, 14.6) is moved by the transport system (16) beyond the transfer medium (12) synchronously with a circumferential speed of the transfer medium (12), and a voltage which, with respect to the transfer medium, is opposite to the charge of the toner, is applied to the receiving device (18.1, . . . , 18.5, 18.6) in the transport system (16).

23. The printing device in accordance with claim 22, wherein each said substrate (14.1, . . . , 14.5, 14.6) is charged by the heating elements (20.1, . . . , 20.5, 20.6) embodied as at least one of infrared radiation devices hot-air blowers and by charging with heat energy.

24. The printing device in accordance with claim 22, wherein each said substrate (14.1, . . . , 14.5, 14.6) can be charged with heat energy by one of a metal tape heating and a metal foil heating device, wherein a wavelength of heat radiation can be exactly matched to an absorption maximum of at least one of the substrate and a plastic matrix of the toner.

25. The printing device in accordance with claim 24, wherein a temperature sensor (26) is assigned to the substrate (14.1, . . . , 14.5, 14.6), at least one of the heating element (20.1, . . . , 20.5, 20.6) and the transport system (16) can be controlled by a control device (24) as a function of a signal emitted by the temperature sensor (26).

26. The printing device in accordance with claim 25, wherein the temperature sensor (26) is a pyrometer.

27. The printing device in accordance with claim 26, wherein a conditioned air flow is directed onto a surface of at least one of the transfer medium (12), and at least one liquid-cooled contact roller of the cooling device (28) roll off on the transfer medium (12).

28. The printing device in accordance with claim 27, wherein the cooling device (28) removes heat energy from the transfer medium (12) downstream of the transfer zone and upstream of the photo-conductor (30) of the printing unit (10.1), viewed in the transport direction of the transfer medium (12).

29. The printing device in accordance with claim 1, wherein the substrate (14.1, . . . , 14.5, 14.6) is fixed in place at least partially on the receiving device (18.1, . . . , 18.5, 18.6).

30. The printing device in accordance with claim 1, wherein the receiving device (18.1, . . . , 18.5,18.6) has an approximately frame-shaped receiving structure for supporting the respective substrate (14.1, . . . , 14.5, 14.6).

31. The printing device in accordance with claim 1, wherein a plurality of printing units (10.1, . . . , 10.5, 10.6) are arranged one behind the other for imprinting each said substrate (14.1, . . . , 14.5, 14.6) in a different color.

32. The printing device in accordance with claim 1, wherein the transport system (16) conducts a plurality of the substrates (14.1, . . . , 14.5, 14.6) arranged one behind the other through the transfer zones of each of the printing units (10.1, . . . , 10.5, 10.6).

33. The printing device in accordance with claim 1, wherein the transport system (16) moves the substrate (14.1, . . . , 14.5, 14.6) continuously.

34. The printing device in accordance with claim 1, wherein upstream of the first printing unit (10.1) of the printing units (10.1, . . . , 10.5, 10.6) arranged one behind the other in the transport direction (A) of the receiving device (18.1, . . . , 18.5, 18.6), the substrate (14.1, . . . , 14.5, 14.6) can be received in a separate receiving device (18.1, . . . , 18.5, 18.6) and can be sequentially conducted to the printing units (10.1, . . . , 10.5, 10.6).

35. The printing device in accordance with claim 1, wherein downstream of the last printing unit (10.6) of the printing units (10.1, . . . , 10.5, 10.6) arranged one behind the other in the transport direction (A) of the receiving device (18.1, . . . , 18.5, 18.6), the substrate (14.1, . . . , 14.5, 14.6) can be removed from the respective receiving device (18.1, . . . , 18.5, 18.6).

36. The printing device in accordance with claim 1, wherein following removal from the receiving device (18.1, . . . , 18.5, 18.6) the substrate (14.1, . . . , 14.5, 14.6) can be transferred to a transfer unit or a sorting unit.

37. The printing device in accordance with claim 1, wherein the transport system (16) has a conveying device (50), which transports the receiving device (18.1, . . . , 18.5, 18.6) along a guidance arrangement (52).

38. The printing device in accordance with claim 1, wherein the conveying device (50) has at least one of a toothed belt, a belt, and a conveying element.

39. The printing device in accordance with claim 1, wherein the guidance device can be an arrangement of one of guide rods (52), guide rails, and guide elements.

40. The printing device in accordance with claim 1, wherein the guidance arrangement (52) forms one of a closed track, and a conveying circuit for conveying the receiving device (18.1, . . . , 18.5, 18.6).

41. The printing device in accordance with claim 1, wherein a cleaning device (54) for the receiving device (18.1, . . . , 18.5, 18.6) is arranged at a closed track or the conveying circuit.

42. The printing device in accordance with claim 1, wherein the cleaning device (54) is arranged following the last printing unit (10.6) of the printing units (10.1, . . . , 10.5, 10.6) arranged one behind the other in the conveying direction of the receiving device (18.1, . . . , 18.5, 18.6), and the receiving device (18.1, . . . , 18.5, 18.6) can be introduced into the cleaning device (54) following the removal of the substrate (14.1, . . . , 14.5, 14.6).

43. The printing device in accordance with claim 1, wherein a cleaning device (54) is arranged upstream of the first printing unit (10.1) of the printing units (10.1, . . . , 10.5, 10.6) arranged one behind the other in the conveying direction (A) of the receiving device (18.1, . . . , 18.5, 18.6).

44. The printing device in accordance with claim 1, wherein the substrate (14.1, . . . , 14.5, 14.6) is respectively received in a separate receiving device (18.1, . . . , 18.5, 18.6) downstream of the cleaning device (54) and upstream of the first printing unit (10.1) of the printing units (10.1, . . . , 10.5, 10.6) in the conveying direction (A) of the receiving device (18.1, . . . , 18.5, 18.6).

45. The printing device in accordance with claim 1, wherein the transfer medium (12) is a transfer roller or a transfer belt containing at least a portion of the cooling device (12).

46. The printing device in accordance with claim 1, wherein the transfer medium (120) of the printing unit (10.1, . . . , 10.5, 10.6) has a lower temperature in the transfer zone formed with the substrate (14.1, . . . , 14.5, 14.6) at least in an area of the contact surface, than a surface of the substrate (14.1, . . . , 14.5, 14.6).

47. The printing device in accordance with claim 1, wherein the substrate (14.1, . . . , 14.5, 14.6) rests on a conductive support of the receiving device (18.1, . . . , 18.5, 18.6) and the support is charged with a reversed polarity sign compared with the charge of the toner.

48. The printing device in accordance with claim 1, wherein the substrate (14.1, . . . , 14.5, 14.6) is moved by the transport system (16) beyond the transfer medium (12) synchronously with a circumferential speed of the transfer medium (12), and a voltage which, with respect to the transfer medium, is opposite to the charge of the toner, is applied to the receiving device (18.1, . . . , 18.5, 18.6) in the transport system (16).

49. The printing device in accordance with claim 1, wherein each said substrate (14.1, . . . , 14.5, 14.6) is charged by the heating elements (20.1, . . . , 20.5, 20.6) embodied as at least one of infrared radiation devices, hot-air blowers and by charging with heat energy.

50. The printing device in accordance with claim 1, wherein each said substrate (14.1, . . . , 14.5, 14.6) can be charged with heat energy by one of a metal tape heating and a metal foil heating device, wherein a wavelength of heat radiation can be exactly matched to an absorption maximum of at least one of the substrate and a plastic matrix of the toner.

51. The printing device in accordance with claim 1, wherein a temperature sensor (26) is assigned to the substrate (14.1, . . . , 14.5, 14.6), at least one of the heating element (20.1, . . . , 20.5,20.6) and the transport system (16) can be controlled by a control device (24) as a function of a signal emitted by the temperature sensor (26).

52. The printing device in accordance with claim 1, wherein the temperature sensor (26) is a pyrometer.

53. The printing device in accordance with claim 1, wherein a conditioned air flow is directed onto a surface of at least one of the transfer medium (12) and at least one liquid-cooled contact roller of the cooling device (28) roll off on the transfer medium (12).

54. The printing device in accordance with claim 1, wherein the cooling device (28) removes heat energy from the transfer medium (12) downstream of the transfer zone and upstream of the photo-conductor (30) of the printing unit (10.1), viewed in the transport direction of the transfer medium (12).
